(19) United States
(12) Patent Application Publication
(10) Pub. No.: US 2008/0256129 A1
(43) Pub. Date: Oct. 16, 2008

(54) Method and System of Creating Media Playlists and Sending to Mobile Devices

(76) Inventors: Robert Salinas, (US); Iain Glendinning, (US)

Correspondence Address: KENYON D. POTTER, 1180 EDDY ST. UNIT C, SAN FRANCISCO, CA, 94109, US

(21) Appl. No.: 11/967,247

(22) Filed: Dec. 30, 2007

Related U.S. Application Data
(60) Provisional application No. 60/882,966, filed on Dec. 31, 2006.

(51) Int. Cl. G06F 17/30

(52) U.S. Cl. 707/104.1; 707/E17.101

(57) ABSTRACT

The field of invention is computer-implemented systems and methods for creating and transmitting media to mobile devices, and in particular, methods and systems for locating, selecting, grouping, and arranging media items in playlists, and transmitting playlists to mobile devices and/or other electronic devices. This invention enhances the usability of mobile devices, and in particular, the usability of any mobile phone by making a user's media or third party media accessible to that user via the mobile phone. An object of the invention is to make any mobile phone a personal media player such as a “MP3 player”, a “Podcast” player, a “slideslow” viewer, and so on.

### PRIORITY CLAIM

This application claims the benefit under 35 U.S.C. Section 119(e) of U.S. Provisional Application No. 60/882,966, filed on Dec. 31, 2006. U.S. Provisional Application No. 60/882,966 is hereby incorporated by reference in its entirety.

### COPYRIGHT RIGHTS

A portion of the disclosure of this patent document contains material that is subject to copyright protection. The copyright owner has no objection to the facsimile reproduction by anyone of the patent document or of the patent disclosure as it appears in the U.S. Patent and Trademark Office patent files or records, but otherwise reserves all copyright rights whatsoever.

### FIELD OF THE INVENTION

This invention relates to systems and methods for creating and transmitting media to mobile devices, and in particular, methods and systems for locating, selecting, grouping, and arranging media items in playlists, and transmitting playlists to mobile devices and/or other electronic devices.

This invention also relates to systems and methods for enhancing the usability of mobile devices, and in particular, methods and systems for efficiently organizing and moving media to mobile devices. Such methods and systems can also be used for distribution of media in varied forms and for varied purposes.

### DEFINITIONS

The following abbreviations and defined terms apply to methods or systems of the inventions described in this document. Abbreviations include but are not limited to acronyms and short hand expressions:
AC area code
AMR adaptive multirate (audio)
CCTV closed circuit TV
CF compact flash (memory)
DGPS digital GPS
DLP digital light processing
DPI dot per inch
DSL digital subscriber line
DTV digital television
ETA estimated time of arrival
FPD flat panel display
FTP file transfer protocol
GPS global positioning system
GUI graphical user interface
HDTV high definition television
HH hour(s)
HTML hypertext markup language
HTTP hypertext transfer protocol
IM instant messag(ing)
IP internet protocol
IR infrared
ISP internet service provider
LAN Local area network
LCD Liquid crystal display
LED Liquid emitting diode (display)
MIDI musical instrument digital interface
MMS multimedia messaging service
NFC near field communication
OEM original equipment manufacturer
PAN personal area network
PDA personal digital assistant
PIN personal identification number
PPI pixels per inch
PPT Powerpoint file
PPS Powerpoint Slideshow
QCIF Quarter Common Intermediate Format
QVGA Quarter Video Graphics Array
QXGA Quantum eXtended Graphics Array
RDF resource description framework.
RF radio frequency
RFI request for information
RFID radio frequency identification
RFRSS radio frequency signal strength
RSS RDF Site Summary or Rich Site Summary (an XML format for syndicating web content)
SD secure digital (memory)
SVGA Super Visual Graphics Array
SXGA Super Extended Graphics Array
SMS short messaging service
SS second (time)
SSR Small screen rendering
TEL telephone
TFT thin film transistor
TV television
° degree (geographical)
′ minute (geographical)
″ second (geographical)
VGA Video Graphics Array
W3C World Wide Web Consortium
WAP wireless application protocol
WAV wave file
WIFI wireless fidelity
WMF Windows media format
WML wireless markup language
XGA extended graphics array
XML extensible markup language
XHTML XML-compliant version of HTML

Definitions and defined terms include but are not limited to the following:

The term “media” means any digital media whatsoever including but not limited to one or more lists, stories, headlines, scores, and so on; one or more songs, tunes, music, and so on; one or more videos, movies, segments, clips, and so on; one or more photos, images, pictures, and so on; one or more items of text, markup language, and so on; or any combination of media. The term “media” also means other forms of content including interactive content such as games, simulations, contests, puzzles, polls, quizzes, surveys, stories where users elect the ending, and so on. For example, digital media text may include text in one or more formats: TXT, RTF, DOC, HTML, XML, and so on. In another example, digital music media may include music in one or more formats: MIDI, MPEG e.g. MP3, WAV, WMF, AMR, and so on. In still another example, digital photo media may include photos, images, pictures and so on, in one or more of the formats: JPEG, GIF, BMP, TIFF, PPT, PPS, PNG and so on. In yet still another example, digital video media may include video in one or more formats: animated GIF, MOV, WMF, EPS, SWF, PNG, G3P, and so on.

The term “media center” means any storage of digital media whatsoever including but not limited to an online or offline repository of digital media. For example, an online repository of digital media may include an online service accessible through the internet, wireless networks, or any network whatsoever. For example, an offline repository may include any electronic device whatsoever including a mobile phone or other mobile device.

The term “group” or “grouping” means any list, collection, mix, assembly, compilation, or collection of any digital media whatsoever. A group or grouping of digital media may comprise one item, several items or many items. In another context, the term “group” or “grouping” also means a group of recipients of one or messages such as a SMS message, a MMS message, and so on.

The term “playlist” means any grouping of media including any form of digital media whatsoever including but not limited to one or more songs or music, one or more videos, one or more photos, pictures or images, one or more items of text, or any combination of media. The term “playlist” also means lists of items (including text or multimedia) comprising scores, highlights, headlines, stock valuations, business metrics, search results, nearby stores or locations, operating hours, real estate comparables, price comparisons, etc. The term “playlist” also means forms of interactive media that may require user response(s) such as quizzes, polls, contests, puzzles, games, and so on. These playlists may take the form of TEXT, multimedia (TEXT, MUSIC and/or VIDEO), or TEXT or THUMBNAILS with LINKS to multimedia, and so on. For example, a playlist may include music in any formats such as MIDI, MPEG e.g. MP3, WAV, WMA, AMR, and so on. For example, a playlist may include pictures, photos, slides, stills, and so on in any format such as JPEG, GIF, BMP, TIFF, PPT, PPS, PNG and so on. For example, a playlist may include videos, clips, trailers, and so on, in any format such as MOV, WMF, EPS, SWF, PNG, G3P, and so on. However, playlist may include any type of media whatsoever including but not limited to a list of items with links to other media. Examples include a list of items comprising text with links to additional text or to photos, music, or videos; the list of items may include a series of images with links to additional text or to photos, music or videos; the list of items may include a series of images with accompanying text with each images and/or text having links to photos, music or videos. In the context of pictures, photos, slides, stills, and so on, the terms “slideshow”, “photo album”, or “face book” may be interchanged with “playlist”. In the context of video, the term “movie”, “video”, “videoshow”, “video recording”, or “podcast” may be interchanged with “playlist”.

The term “screen” means any visual display including but not limited to a CRT, LED, LCD, FPD, TV, HDTV, projection screen, etc., and is used interchangeably with the term “visual display”. A screen is capable of displaying M pixels by N lines whereby a screen with 800 pixels by 600 lines is capable of displaying 800 distinct dots on each of 600 lines, or about 480,000 pixels

The term “screen resolution” means the clarity or sharpness of a display and is signified by the number of dots (pixels) on the entire screen and denoted by M pixels×N lines and is contrasted with unitized “resolution” which is signified by DPI or PPI.

The term “full size screen” means any visual display capable of a screen resolution of at least 800 pixels by 600 lines (e.g. SVGA), and typically has 1024 by 768 pixels (e.g. XGA), or 1248 by 1024 pixels (e.g. SXGA), 2048 by 1536 pixels (e.g. QXGA), and so on. The term “full size screen” also means any visual display regardless of type of hardware including but not limited a CRT, LED, LCD, FPD, TV, HDTV, projection screen, and so on.

The term “miniature size screen” is any screen that has fewer pixels than a full size screen including but not limited to 640×480 pixels (e.g. VGA), 320×240 pixels (e.g. QVGA), or 352×288 pixels (e.g. CIF), or 176×144 pixels (e.g. QCIF), and so on. The term “miniature screen” also means any visual display including but not limited a LED, LCD, FPD, TV, HDTV, and so on.

The term “mobilize” means conversion of one or more webpages that are capable of being displayed on a computer with a full size screen, e.g. desktop, laptop or notebook, to a one or more webpages that can be displayed on at least one mobile device with a miniature screen, e.g. PDA, mobile phone, smart phone, and so on. The term “mobilize” also means the conversion of one or more webpages that are capable of being displayed on a computer with a full size screen to one or more webpages that can be displayed on both a computer with a full size screen and at least one mobile device with a miniaturescreen, or that can be displayed on a computer with a full size screen and multiple mobile devices with miniature screens. The term “mobilize” also means creation of one or more webpages that are capable of being displayed on at least one mobile device with a miniature screen, e.g. PDA, mobile phone, smart phone, and so on, with or without benefit of one or more pre-existing webpages as a starting point. As used herein, the term “conversion” includes but is not limited to selecting, arranging, and/or adapting content from one or more existing webpages for display on mobile devices, substituting existing representations of such content with images, pictures, iconographics and/or symbols, and supplementing existing content with additional content such as text, pictures, and so on. As used herein, the term “creation” includes but is not limited to selecting, arranging, and/or adapting content from any source (digital or non-digital) for display on mobile devices.

The term “area code” means digits 1-3 of a 10-digit telephone number representing a unique code that corresponds to a particular geographic area, e.g. 415 is the area code for the city of San Francisco, Calif. In a full telephone number, the digits of “area code” typically precede the digits of the “exchange code”. The term “area code” may also be known as “city code” and these terms may be used interchangeably.

The term “day” is any day or date whatsoever and can mean any period of time having a 24-hour duration including but not limited to a calendar day, a working day, a day of week, a day of month, a day of year, any holiday, e.g. Valentine's day, New Year's Eve, New Year's Day, Christmas Eve, Christmas Day, Independence Day. and so on. The “term” day may also mean “date” or “calendar date” and these terms may be used interchangeably. See also “time of day” defined below.

The term “country code” means the number, e.g. typically 2 digits, that precedes the telephone number and is a unique code that corresponds to a particular country.

The term “delivery” means delivery in any form whatsoever including but not limited to delivery by voice messages, text messages, IM, email with or without attached documents, multi-media including streaming, tickers, RSS, WAP, internet, messaging service, narrowcast, and so on, and may utilize any communication protocol such as IP, mobile IP, FTP, HTTP, HTTPS, and so on.

The term “device” means any electronic device including but not limited to mobile electronic devices or immobile electronic devices that are capable of either one-way or two-way communications including but not limited to cellular phones, handheld radios, pagers, laptop computers, notebook computers, ultra-compact computers, desktop computers, set-top boxes, cable boxes, satellite phones, video phones, PDAs, MP3 players, devices on-board vehicles including but not limited to planes, ships, cars or trucks, and so on, and RFID devices attached to other tangible items such as products, packaging, shelves, displays, signs, exhibits, and so on.

The term “exchange code” means digits 4-6 of a 10-digit telephone number or digits 1-3 of a 7-digit telephone number. In the latter context, the term “exchange code” may also be known as a “prefix”, e.g. NXX, and these terms may be used interchangeably. In a full telephone number, the digits of “exchange code” typically follow the digits of the “area code”.

The term “identifier” means any information in any form whatsoever that uniquely identifies a device including but not limited to a telephone number, a device identification number, a device's name, a user's name, a street address, a pre-assigned identification number, a user-defined passcode, a pre-assigned or user-defined username, birthplace, and so on.

The term “internet service provider” means any person or entity whatsoever that provides an access point to the internet including but not limited to telephone companies, telecommunications companies, cable companies, media companies and any other commercial organizations as well as universities and other institutions, not-for-profits, community associations, government entities, and so on.

The term “message” means information in any form whatsoever including but not limited to a text message, picture, photo, cartoon, audio, video, animation, presentation, and so on, and any combination of these forms include multi-media message, audio-video, voice over animation, voice over presentation, pictures or photos with captions, cartoons with captions or call-outs, and so on. For example, a message may be a SMS message, a MMS message, an email, an IM, a voice message, or any other type of electronic message. A message can be an advertisement or promotional information pushed by an advertiser to a user's mobile device, a message requested by the user of the device, or any message initiated by any person, organization, or entity. A message may be initiated in response to a specific request or in response to an automated protocol.

The term “narrowcast” means transmission of a RF signal, or the act of transmitting a RF signal, from a source resulting in receipt of the RF signal in relatively small geographical area. A narrowcast can be from any RF source whatsoever including but not limited to a single cell tower, a transmitter, a base station, a repeater station, a two-way radio, a bluetooth source, a RFID source, a NFC source, any electronic device capable of RF transmission, and so on. The geographical area of a narrowcast typically has a maximum range of up to 10 kilometers but may have a lesser or greater range.

The term “near field communication” means transmission of a RF signal, or the act of transmitting a RF signal, from a source resulting in receipt of the RF signal in a small or very small spatial area. A near field communication can be from any source such as an electronic device, a POS device, a RFID source, a NFC source, a microchip, and so on, or any source attached to or embedded in another electronic device. The spatial area of a near field communication typically has a maximum range up to 1 meter but may have a lesser or greater range.

The term “network” means any communications network, any subnetwork (aka “subnet”) or any combination of these, including but not limited to ethernet, LAN, WAN, PAN, internet, intranet, extranet, wired network, wireless network, telephone network, cellular network, cable network, satellite network, a mesh of network connections or access points, and so on, including but limited to transmission via conventional electrical conductors, twisted pair, Cat-V, Cat-10, or Cat-100 cables, coaxial cables, fiberoptic cables, DSL, broadband, light transmission, laser transmission, and RF transmission at any frequency, and so on.

The term “purchase” means any type of acquisition whatsoever including but not limited to outright purchase, subscriptions, payment plans, and so on. The term “purchase” also means both paid acquisitions, e.g. purchases, paid subscriptions, and so on, and non-paid acquisitions (with or without registration) such as downloads, trial versions, shareware, freeware, music or video clips, movie trailers, promotional media, and so on.

The term “telephone number” means a number that corresponds to a particular electronic device including but not limited to a mobile phone, PDA, an electronic device connected to a landline, and so on. A telephone number typically corresponds to an electronic device that is capable of voice communications but also correspond to an electronic device that is capable of voice, facsimile, text, and/or video communications.

The term “time” means the duration of time as measured in seconds from an established point in time to the current time of day as measured in years, days, hours, minutes, seconds, or any combination of these, where a year comprises about 365.25 days, a day comprises 24 hours, an hour comprises 60 minutes, and a minute comprises 60 seconds. By convention, time is often measured as the number of seconds from beginning of Jan. 6, 1980. The term “time” can also mean anything that represents time or has temporal significance, e.g. time of day, time of month, time of year, summer time, and holiday's including St. Valentine's day, New Year's eve, Christmas, the time between thanksgiving and Christmas, etc. See also the term “time of day” defined below.

The term “time of day” means the time of day in any form whatsoever including time of day as measured in hours, or a combination of hours and minutes, e.g. HH:MM, or a combination of hours, minutes, and seconds, e.g. HH:MM:SS, from the beginning of the current day where a day comprises 24 hours, an hour comprises 60 minutes and a minute comprises 60 seconds. The term “time of day” may also be measured in a portion of a 24-hour period that occurs each day such as morning, afternoon, evening, night, breakfast, lunch, dinner, dawn, sunrise, dusk, sunset, and so on.

The term “wireless service provider” means any person or entity whatsoever that provides access to the internet and/or other network(s) including but not limited to telephone companies, telecommunications companies, cable companies, media companies and any other commercial organizations as well as universities and other institutions, not-for-profits, community associations, government entities, and so on. Access may be WIFI (including any type of 802.11 network, e.g. 802.11b, 802.11a, 11g, dual-band, etc.), bluetooth (including any type of personal area network), broadband, or any other wireless protocol and may be connected through a wireless access point, a host device with wireless capability, or any other means of access such as a publicly accessible grid of devices (or mesh).

### BACKGROUND OF THE PRESENT INVENTION

Prior methods of moving digital media and data from one computer to another computer required a physical connection, e.g. a communications cable or a portable storage medium or a network. For example, media and data could be transferred with a communications cable and specialized software called PC Link. For example, media and data could be transferred with a portable storage medium such as CF, SD, and so on. As an alternative, media and data could be transferred using a network and required communications devices, e.g. a network card, modem, and so on, and specialized communications software. With the advent of wireless networks, e.g. WIFI, Bluetooth, etc., digital media and data could be transferred without a physical connection. However, the sending computer and the receiving computers still require modems or their wireless equivalent.

Similarly, prior methods of moving digital media and data from a computer to a mobile device required a communications device on-board the mobile device. For example, some mobile devices, e.g. notebooks, have traditional modems and/or wireless equivalents such as Bluetooth to connect to the internet. For example, other mobile devices, e.g. mobile phones, have radio frequency (RF) transmitters and receivers to connect to wireless networks such as PCS, GSM, 3G, and so on.

Due to the potential demand for substantial network bandwidth, wireless providers are encouraging the return to use of physical connections for transference of media and data to mobile phones as an alternative to wireless networks. For example, media and data may also be transferred to mobile devices using physical connections, e.g. a communications cable (e.g. USB or Firewire) or a storage card (e.g. CF or SD), and specialized communications software. Prior methods teach users to depend on physical connections, and thus, forsake an essential part of cell phone mobility.

Initially, network capacity was a perceived problem for transmission of music and video media. The demand for network capacity was alleviated in part by the increasing bandwidth capacity of wireless networks, e.g. 3G. Yet, wireless providers still consider network capacity to be a problem for transmission of music and video media despite plan for increased network capacity, e.g. 5G, 10G, etc. One issue that affects bandwidth is the predominance of “streaming” media, e.g. real time radio and newcasts, via the internet. Streaming media requires bandwidth each time the media is played whereas downloaded media only requires bandwidth when it is initially downloaded.

Even if network bandwidth were not a problem, a mobile device still requires sufficient on-board memory to store media, e.g. a playlist. Unlike many newer mobile devices with removable storage cards, older mobile phones do not have substantial onboard memory. Thus, on-board memory remains an issue for transference of media, including music media.

Many online services offer customers the ability to download music to their computers through the internet and then transfer to mobile devices, e.g. a mobile phone, using a physical connection. For example, such online service is offered by Yahoo! Music of Santa Clara, Calif. However, these online services does not support downloading music directly to a mobile phone using the phone's wireless network nor does it allow transfer of music to any mobile phone but only compatible devices.

Another online service offered by Digeo, Inc. of Kirkland, Wash. allows users the ability to download music directly to their mobile phone over the wireless provider network. However, the service allows only downloads of radio programs or downloads of newly purchased digital media.

No online service offers users the ability to download their own music from their personal music center directly to their mobile phone using the phone's wireless network. A long felt need is an online service that allows users to transfer music from their computers to their mobile devices, e.g. mobile phones, and playback.

Wireless service providers offer services through their cellular networks to browse and/or download music and/or video to a user's mobile device, e.g. mobile phone. Browsing often consists of online listening to streaming media while downloading consists of transferring a copy to the user's mobile device for offline playback. For example, one such service is VCAST offered by Verizon, Inc. of Los Angeles, Calif. However, no wireless service provider offers a service to transfer media files from a user's computer to that user's mobile phone using the provider's network despite the availability of network bandwidth for MMS messages. Instead, wireless providers instruct a user to take advantage of the innate capabilities of that user's mobile device to transfer media, if such capability exist, by employing a physical connection, e.g. cable or storage card, as described above. Although some mobile phones have such capability, many do not. Even if the number of mobile phones with such capability is increasing, continuing to resort to a physical connection in a digital world is inconvenient and unnecessary.

Thus, an online service that offers a service to transfer a user's media to that user's mobile device would satisfy a long felt need. Such a service may comprise an initial step of transferring a user's media from his/her personal media library to a personal online repository and then a subsequent step transferring that user's media to his/her mobile device including any mobile phone regardless of whether or not the mobile phone has innate capabilities to transfer media using a cable or storage card. Alternatively, the service could perform the transfer directly from a user's computer to that user's mobile phone.

Ideally, such a service would automatically identify the mobile phone and its network protocols and transfer the media using the correct protocols. Even if a prior method exists for an online service or wireless provider to transfer music to users through its network, there remains the issue of interoperability with other provider networks that necessitates a difference in coding required for different network protocols and different mobile platforms due to functionality specific to mobile devices.

Mobile phones have heretofore been designed and used for multiple purposes. Mobiles phones are undoubtedly designed to be used for communication purposes. In addition, mobile phones are designed to be used for other purposes such as calculators, calendars, notepads, and games. Mobile phones are increasingly becoming the standard ‘device’ for mobile communications as well as many other purposes. The market for mobile phones is continuing to experience significant growth and appears to be merging with the market for PDAs such as the iPAQ made by Hewlett-Packard or the Treo made by Palm, Inc. As such, the most popular device of today and tomorrow is likely to be a mobile electronic device that includes wireless communications including voice, email, IM, and so on plus other applications such as calendar, calculator, notes, navigation, and so on. Mobile devices can also function as a user's MP3 player or Podcast player or for playback of any type of media including movies, slideshows, and so on.

Whether contracts on a monthly, annual or biennial basis or prepaid agreements, subscriptions are the primary source of revenue in the mobile phone industry. Under the subscription model, a user of a mobile phone subscribes to a service plan. Sales of auxiliary features, e.g. text messages, ringtones, etc. are currently a secondary source of revenue. Yet, these are often included as a standard feature, offered as a premium feature, or bundled with standard or premium features in the subscription revenue model. However, mobile phones are often sold at or below cost in order to promote purchase of subscriptions. Hence, subscriptions are the profit center of the mobile phone industry.

Given this industry model, the mobile phone industry has lacked other sources of revenue. In addition to advertising, an add-on feature that is developing as a substantial revenue stream is revenue sharing of sales of licensed media, e.g. music, ringtones, etc. However, individual users would like to transfer their media, e.g. music, to their mobile phones so that they can playback the media offline and without having to re-purchase media which they already own. As a result, the existing services offered by wireless providers are suboptimal and often ineffective to assist users of mobile phones.

Heretofore, the prior art does not tailor services in a manner that provides effective assistance to users of mobile device for comprehensive media services. In particular, except for mobile radio services, the prior art does not show methods that satisfy each user's use of that user's content as well as combining that user's content with sales of new licensed content.

### SUMMARY OF THE INVENTION

This invention relates to systems and methods for creating and transmitting media to mobile devices, and in particular, methods and systems for locating, selecting, grouping, and arranging media items in playlists, and transmitting playlists to mobile devices and/or other electronic devices.

This invention also relates to systems and methods for enhancing the usability of mobile devices, and in particular, methods and systems for efficiently organizing and moving media to mobile devices including mobile phones. Such methods and systems can also be used for distribution of media in varied forms and for varied purposes.

An object of the present invention is to enhance the usability of any mobile phone by making a user's media accessible to that user via the mobile phone.

An object of the present invention is to make any mobile phone a personal media player such as a “MP3 player”, a “Podcast” player, a “slideslow” viewer, and so on.

Another object of the present invention is to allow a user to upload media to that user's personal online repository.

Another object of the present invention is to allow a user to store media accessible through the internet to that user's personal online repository.

Another object of the present invention is to allow a user to select, arrange, or organize media stored in that user's online repository.

Another object of the present invention is to organize media into one or more playlist(s).

Another object of the invention is to send a MMS message to mobile devices, e.g. mobile phones, that includes one or more playlist(s).

Another object of the invention is to retrieve media from the user's computer and send playlist(s) to the user's mobile device.

Another object of the invention is to store copies of online media, or links to media if accessible only in streaming format such as webcasts, podcasts, and so on.

One embodiment of the invention involves a method comprising a step of uploading media from a user's computer to an online repository, and a subsequent step of sending a MMS message to that user's mobile phone. For example, the step may include user uploading one or more songs to the online repository, and the subsequent step may include user sending MMS message containing these songs to that user's mobile device as a playlist. An alternative embodiment of the invention includes a method having a step of purchasing media file(s) and saving media file(s) in an online or offline repository, and a subsequent step of sending a MMS message containing these media to that user's mobile device as a playlist.

Another embodiment of the invention includes a method having an intermediate step of organizing media file(s) into one or more playlists. These media file(s) can be organized using multiple criteria including artist, genre, album, live shows, and so on. Alternatively, these media file(s) can be organized using by the user. For example, a user may group songs into playlists for different activities or moods such as “party mix”, “study mix”, “romantic mix”, “workout mix”, and so on. In another example, the songs or other media are automatically organized into playlists based using multiple criteria including artist, genre, album, and live shows as well as user preferences or behavior. In still another example, the media also include featured or promoted media. In yet still another example, the media also include media determined by one or more recommendor systems.

In these examples, each song in a playlist may be unique to that playlist or may be part of multiple playlists. In these examples, each playlist may be named by the user or be assigned a unique identifier. In these examples, each song may be uploaded and stored in varied media formats, e.g. MID1, MP3, WAV, AMR and so on. In the preferred embodiment, each song is converted to a compressed media format such as AMR that is recognizable by mobile phones, and similarly, each picture or photo is converted to a compressed media format such as JPEG, GIF, animated GIF, and so on and each video or movie clip, trailer, promo, and so on is converted to a compressed media format such as 3gp. An example a grouping of media in a playlist is shown in Table 1 below.

TABLE 1
Playlist001

| Item | Song Title | Filename |
|---|---|---|
| 1 | song001 | song001.amr, .mp3, or .mid |
| 2 | song002 | song002.amr, .mp3, or .mid |
| 3 | song003 | song003.amr, .mp3, or .mid |
| . | . | . |
| . | . | . |
| . | . | . |
| N | song00N | song00N.amr, .mp3, or .mid |

An example of a grouping of media in a slideshow (a type of “playlist”) is shown in Table 2 below:

TABLE 2
Slideshow001

| Item | Slide Title | Filename |
|---|---|---|
| 1 | slide001 | slide001.gif |
| 2 | slide002 | slide002.gif |
| 3 | slide003 | slide003.gif |
| . | . | . |
| . | . | . |
| . | . | . |
| N | slide00N | slide00N.gif |

An example of a grouping of media in a videoshow (a type of “playlist”) comprising a collection of video clips, movie clips, ad, or podcasts is shown in Table 3 below:

TABLE 3
Videoshow001

| Item | Clip Title | Filename |
|---|---|---|
| 1 | clip001 | clip001.3gp |
| 2 | clip002 | clip002.3gp |
| 3 | clip003 | clip003.3gp |
| . | . | . |
| . | . | . |
| . | . | . |
| N | clip00N | slide00N.3gp |

An example of a grouping of media in a medialist (a generalized “playlist”) comprising a collection or list of items of media including stories, reports, scores, headlines, stock valuations, business metrics, product descriptions, product pricing, bestsellers, showtimes, horoscopes, team members, contestants, candidates, nearby store locations, nearby friends or family, real estate comparables, and so on, is shown in Table 4 below:

TABLE 4
MediaList001

| Item | Clip Title | Filename |
|---|---|---|
| 1 | MediaList001 | medialist001.wml, .html, .gif, or .3gp |
| 2 | MediaList002 | medialist002.wml, .html, .gif, or .3gp |
| 3 | MediaList003 | medialist003.wml, .html, .gif, or .3gp |
| . | . | . |
| . | . | . |
| . | . | . |
| N | MediaList00N | medialist00N.wml, .html, .gif, or .3gp |

Continuing the examples where a user organized one or more media file(s) in a playlist, the user is presented with alternatives for organizing media. In one embodiment, the user is presented with a choice of one or more templates or forms which have varying levels, e.g. basic versus advanced, novice versus expert, and so on. In other embodiments, the templates or forms may be customizable by the user. For example, the template may allow the user to select a playlist at the time of uploading that user's media file. Alternatively, the user may upload that user's media file and select a playlist at a later time. As a further alternative, the user may elect not to organize media in any playlist or grouping, or to apply a default setting.

After the media are accessible in the online repository, one or more playlists would be sent to that user's mobile phone. In one embodiment, the playlist is sent to a mobile phone as a MMS message. In another embodiment, the playlist is sent to a mobile phone as an email or IM. In still another embodiment, the playlist is sent to a mobile phone using an alternative network protocol for wireless devices such as Bluetooth or WIFI (aka 802.11). In yet still another embodiment, the playlist is mobilized prior to sending to the mobile phone.

In addition, a user may schedule the transmission of playlist(s). In one embodiment, the user schedules the time to send the MMS message applicable to each playlist, e.g. NOW, TODAY at NOON, TODAY at 5 PM, TOMORROW at 8 AM, FRIDAY at 8 PM. In still another embodiment, the user schedules a recurring MMS message for one or more playlists. In other embodiments, the user may opt-in to receive additional MMS messages comprising varied media files from third parties and the service may allow the user to schedule when to receive these additional MMS messages. These additional MMS messages may include announcements, promotions, licensed content, and so on.

Since an MMS message considered one object, many mobile phones play the components of the MMS message in sequence, and typically, without intervening pauses or stops. Thus, the MMS protocol makes the mobile phone ideal for playlists whether they be comprised of music, photos, or video clips.

Still yet another object of the invention is to improve efficiency of information distribution such as that media contain important information can be distributed interested users of mobile devices. Typically, real estate agents, political campaigns, and organizers and promoters of events, and media and entertainment companies, among others, create hardcopy “flyers”, pamphlets, coupons, and similar materials for promotion purposes. In comparison to paper flyers, distributing digital information is inexpensive, requires less time and effort, and does not add to the waste stream. Although the internet partially obviates the need for hardcopy flyers, a need for mobile information still exists and browsing using a mobile phone has inherent limitations. In contrast, MMS messaging is both mobile and overcomes the inherent limitations of browsing. An example of a type of media that can be sent by MMS message to mobile phones is flyers, pamphlets, coupons, and other similar promotional materials.

Such promotional materials may be sent in varied media formats including images, videos, and so on. In one embodiment, one or more such promotional materials are additional MMS messages sent separately to a user's mobile phone. In another embodiment, one or more promotional messages are additional MMS messages sent to the user's mobile phone simultaneously with MMS messages scheduled or requested by the user. In still another embodiment, one or more such promotional messages are intermixed within a user's playlist in a single MMS message. The mobile phone of the user may or may allow user to skip the promotional message but a message produced with high quality content will be heard by many users.

Still yet another object of the invention is for advertising and promotion of manufacturers and vendors of any goods and services that are targeted to a specific geographic location(s) such as southern locations, northern locations, state specific, MSA specific, community specific, resort destination(s), rather than targeted to other users such as specific demographic, e.g. tweens, teenagers, 18-34 year-olds, baby boomers, and so on.

Still yet another object of the invention is integration of targeted media including but not limited to mobile advertising, marketing, campaigning, promotion and/or sales within a mobile communications device to add to the value of the device without detracting from the value of device as a communications tool. Although a message may be displayed on the device prior to making a connection to a network for purposes of communication, display of a message prior to making a connection may delay, and thus, detract from the value of the device as a communications tool. Yet, a message may also be displayed of the device without detracting from its value by being displayed when the user is dialing a telephone number and/or after termination of a communication. For example, if the message is a sound bite, it would fit in during dialing. A longer message could be paused during a communication and resumed when the communication is terminated.

### BRIEF DESCRIPTION OF THE DRAWINGS

FIG. 1 is a flowchart of a combination of processes for obtaining media (by uploading, browsing and/or acquiring media), organizing media files (by grouping and/or arranging media items in playlists), scheduling transmission of media files, and transmitting playlists to mobile devices and/or other electronic devices.

FIG. 2 is a flowchart of a process to upload media file(s) to an online repository.

FIG. 3 is a flowchart of a process to browse media file(s) and/or save copies to a online or offline repository.

FIG. 4 is a flowchart of a process to purchase media file(s) and/or save copies to a online or offline repository.

FIG. 5 is a flowchart of a process to define a new playlist.

FIG. 6 is a flowchart of a process to organize media files in one or more playlist(s).

FIGS. 7 and 8 are alternative flowcharts of processes to schedule transmission of one or more playlist(s).

FIGS. 9 and 10 are alternative flowcharts of processes to transmit playlist(s) comprising one or more media file(s).

FIGS. 11A and 11B are schematic drawings of alternative circuits of mobile devices.

FIGS. 12A, 12B, and 12C are schematic drawings of alternative circuits of other electronic devices including stationary electronic devices.

FIGS. 13A through 13D are perspective drawings of alternative mobile devices.

FIG. 13E is a perspective drawing of a stationary electronic device.

FIGS. 14A, 14B and 14C are schematic drawings of alternative networks for mobile devices.

FIGS. 14D and 14E are schematic drawings of alternative networks for other electronic devices.

### DETAILED DESCRIPTION OF THE INVENTION

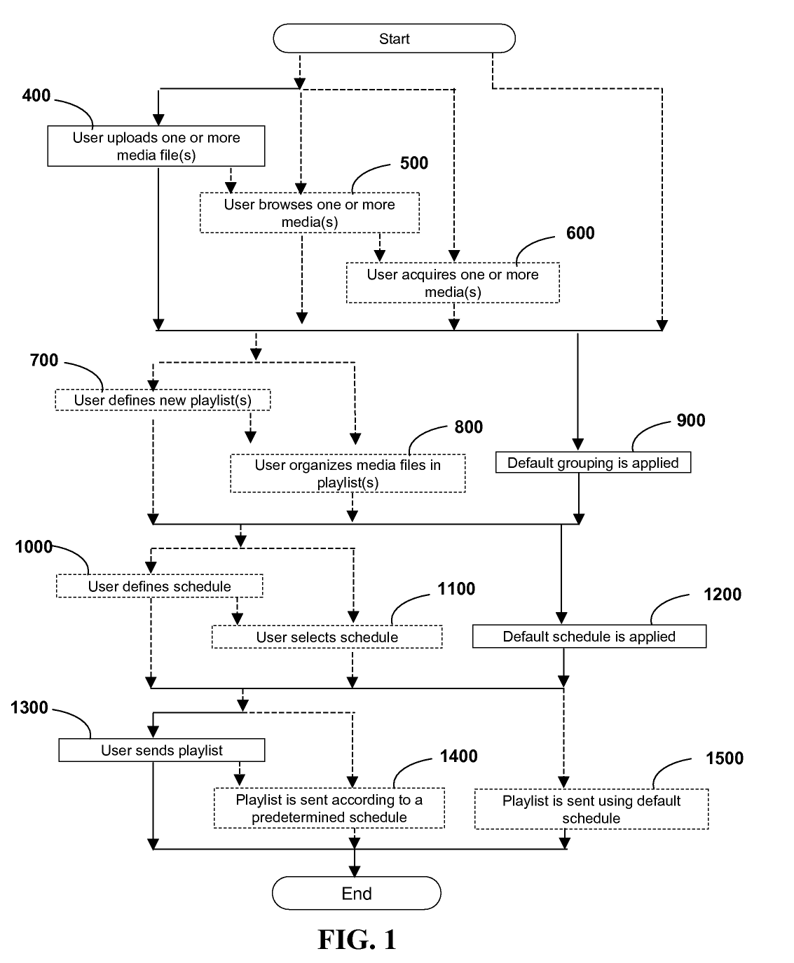

With reference to FIG. 1 through FIG. 10, processes and subprocesses are depicted by boxes having either solid or dashed lines. Required steps are depicted by boxes having solid lines. Alternative and/or additional steps are depicted as boxes having dashed lines.

In FIG. 1, the methods and systems of the invention includes a combination of processes for obtaining media files (by uploading, browsing and/or purchasing media), defining new playlist(s), organizing media files (by grouping and/or arranging media items in playlists), scheduling transmission of media file(s), and/or transmitting playlists to mobile devices. One embodiment of the invention includes subprocesses 400, 800, 1100 and 1400. For example, a user uploads one or more media files from that user's personal media collection to that user's online repository, adds the media file(s) to a playlist, and schedules transmission of the playlist to that user's mobile phone, and playlist is sent to that user's mobile phone using selected schedule. Another embodiment includes subprocesses 600, 800, 1100 and 1300. For example, a user purchases one or more media file(s), saves the media file(s) to that user's repository, user organizes media file(s) in a predefined or default playlist, e.g. “New Additions” or “New Releases”, a predefined or default schedule is applied, and playlist is sent to that user's mobile phone using the default schedule. In still another embodiment the invention includes subprocesses 500, 800, 1200 and 1500. For example, a user browses one or more media file(s), organizes the file(s) in one or more playlist(s), a default schedule is applied, and the playlist(s) are sent using the default schedule. In a further embodiment, an additional step may include a user defining one or more new playlist(s). In yet still another embodiment, one or more of featured or promoted media file(s) are added to one or more playlist(s). In yet still another embodiment, shortened versions or “clips” of user selected or featured media file(s) are added to one or more playlist(s).

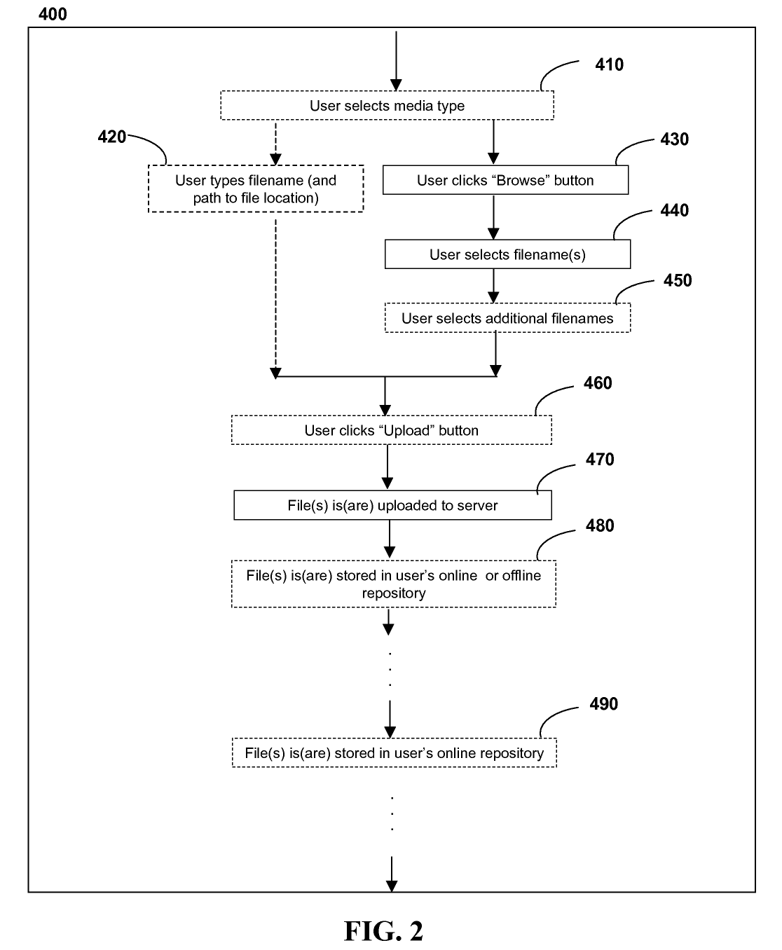

In FIG. 2, the process comprises uploading one or more media file(s) from a user's computer 110 or mobile device 100 to an online repository stored on a server 200. The process includes the steps 430, 440, and 470. The process may also include alternative and/or additional steps 410, 420, 450, 460, and/or 480. In one embodiment, the user's computer 110 is a desktop computer containing one or more digital media files that are playable using software such as RealPlayer made by Real Networks, Inc. or Windows Media Player made by Microsoft Corporation. In another embodiment, mobile device 100 is a notebook computer or a handheld computer containing one or more digital media files. In still another embodiment, mobile device 100 is a mobile phone containing digital media files.

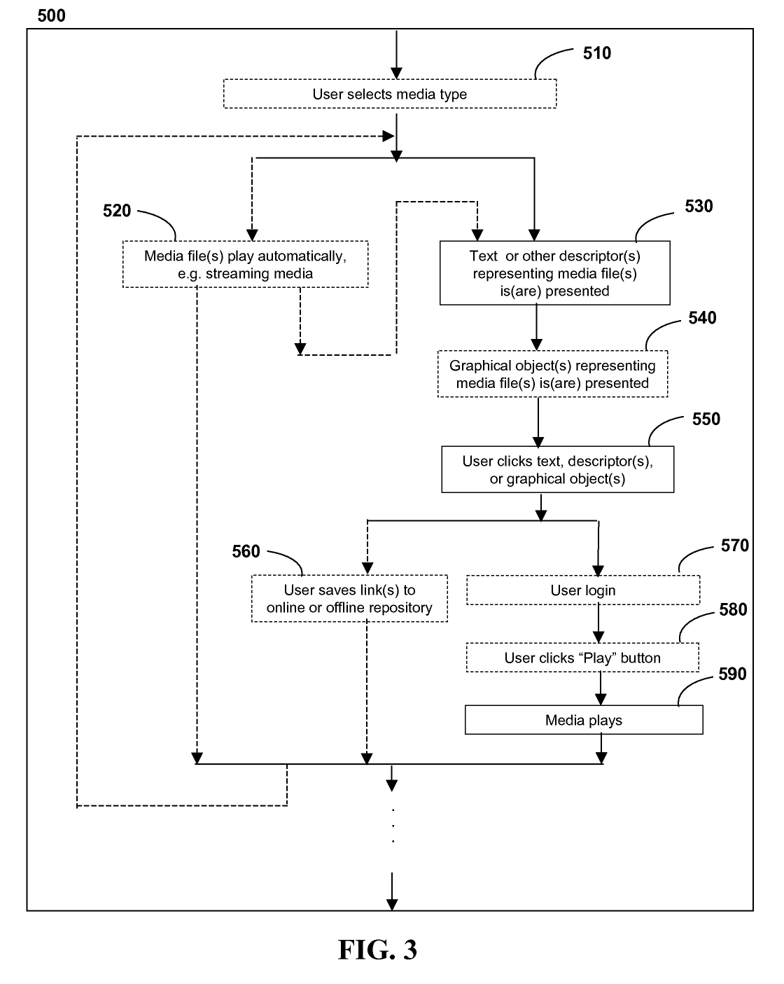

In FIG. 3, the process comprises browsing one or more media file(s) and/or saving media file(s) in an online or offline repository stored on a computer 110, a mobile device 100, or a server 200. The process includes the steps 530, 550, and 590. The process may also include alternative and/or additional steps 510, 520, 540, 560, 570, and/or 580. In one embodiment, descriptor(s) is(are) text. In another embodiment, descriptor(s) is(are) image(s) or graphical object(s). In still another embodiment, descriptor(s) have links to other files and/or information.

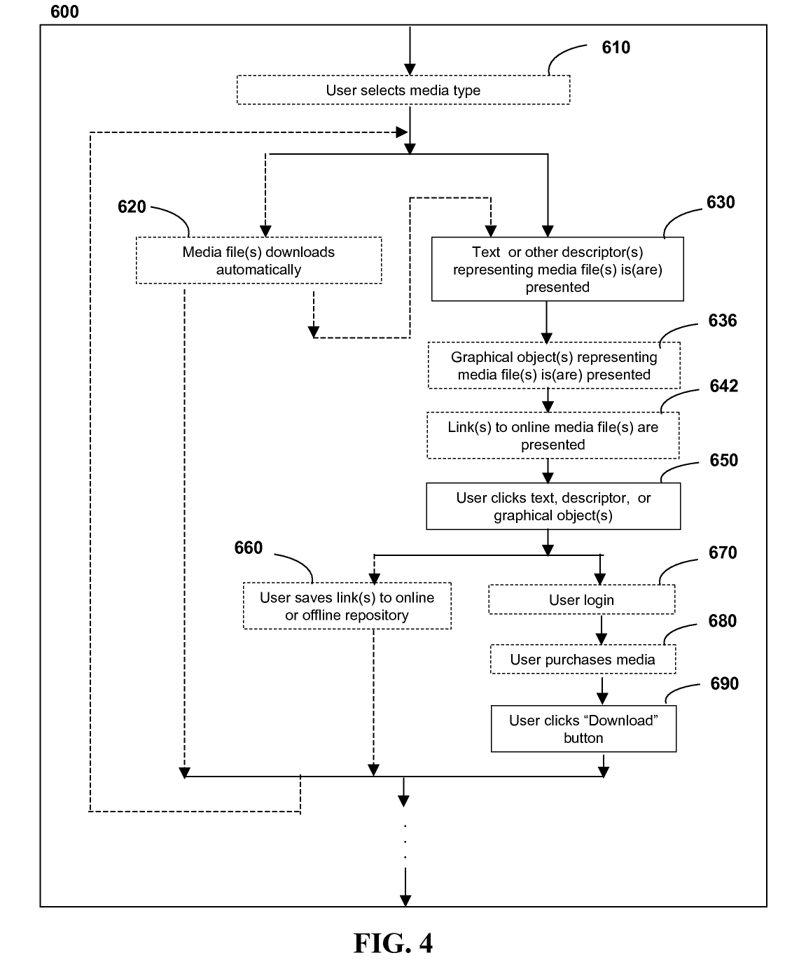

In FIG. 4, the process comprises purchasing one or more media file(s) and/or saving media file(s) in an online or offline repository stored on a computer 110, a mobile device 100, or a server 200. The process includes the steps 630, 650, and 690. The process may also include alternative and/or additional steps 610, 620, 636, 642, 660, 670, and/or 680.

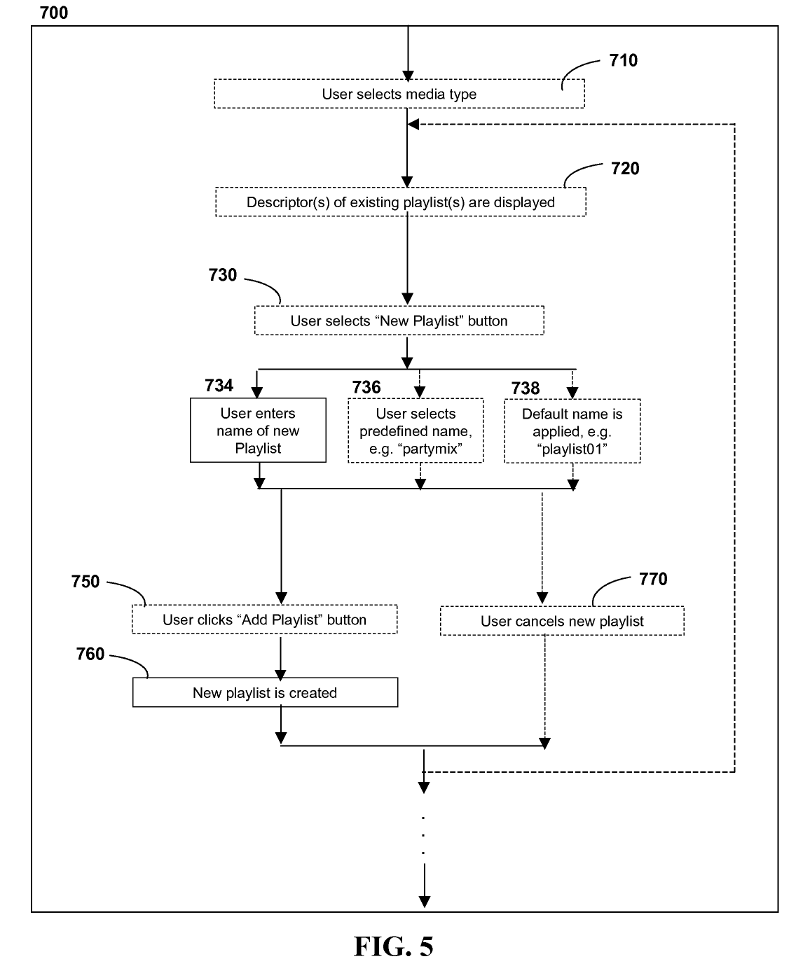

In FIG. 5, the process comprises defining a new playlist. The process includes the steps of 734 and 760. The process may also include alternative and/or additional steps 710, 720, 730, 736, 738, 750 and/or 770. In one embodiment, a name of a new playlist is typed by the user. In another embodiment, the name of a new playlist is selected from predefined list of suggested names, e.g. “partymix”. In still another embodiment, a default name is applied to the new playlist, e.g. “playlist01”.

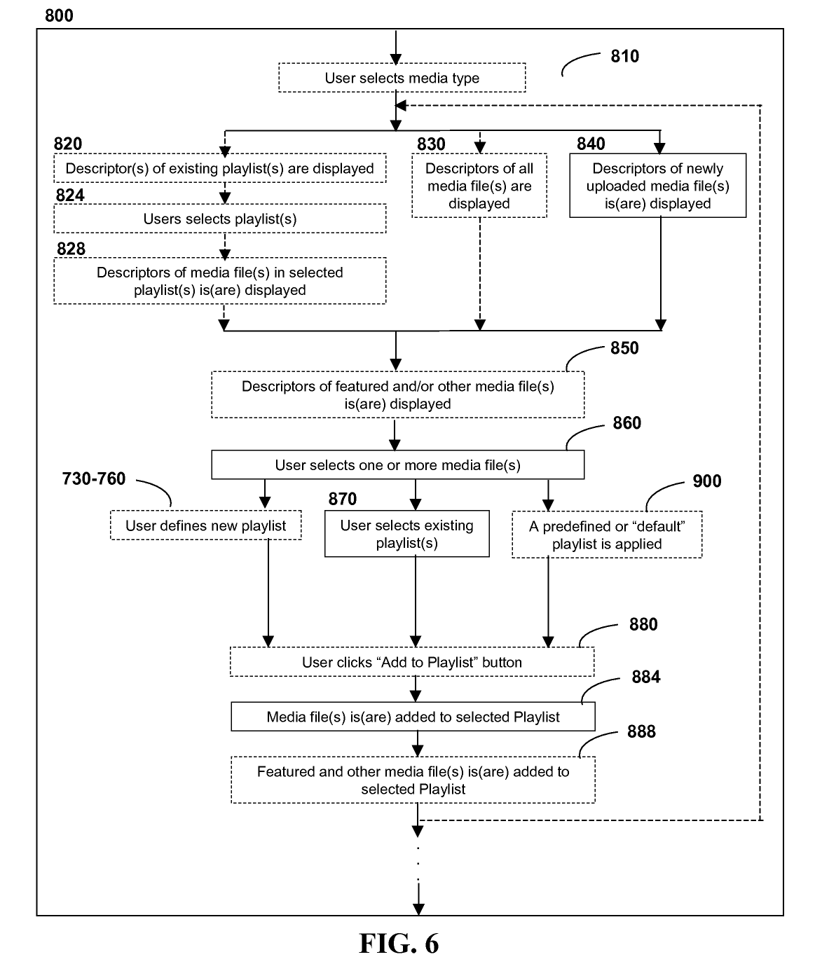

In FIG. 6, the process comprises organizing one or more media file(s) into a playlist. The process includes the steps 840, 860, 870, and 884. The process may also include alternative and/or additional steps 810, 820, 824, 828, 830, 850, 880 and/or 888.

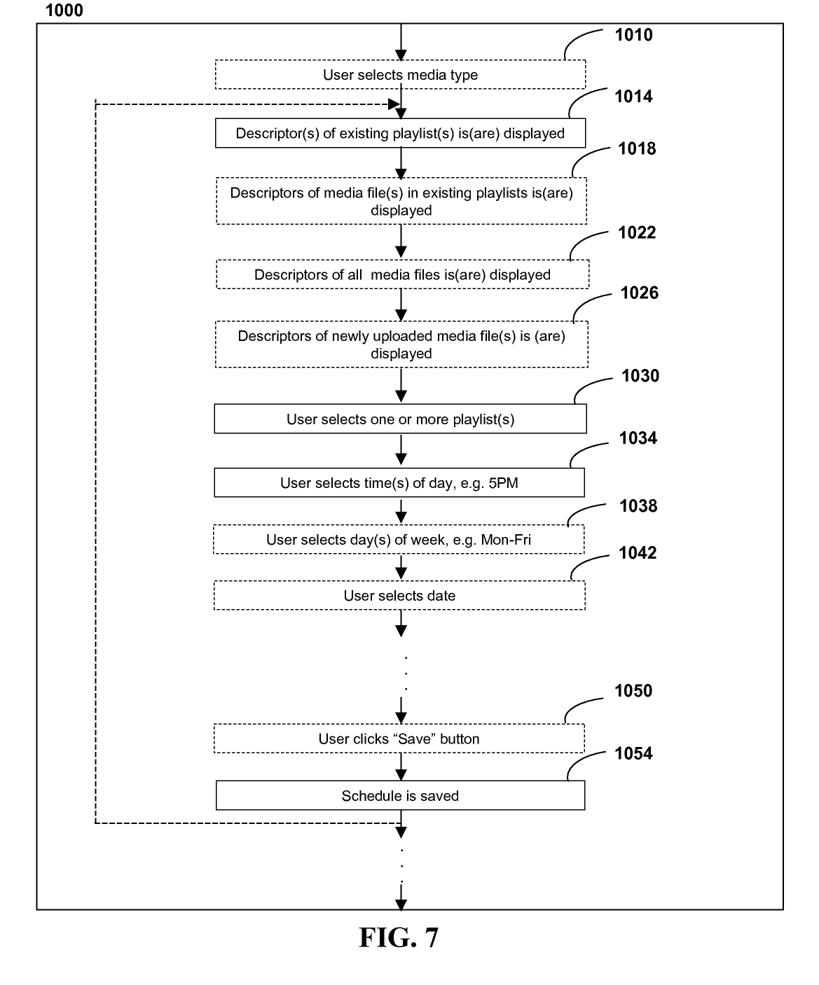

In FIG. 7, the process comprises defining a schedule for transmission of one or more playlist(s). The process includes the steps 1014, 1030, 1034, and 1054. The process may also include alternative and/or additional steps 1010, 1018, 1022, 1026, 1038, 1042 and/or 1050.

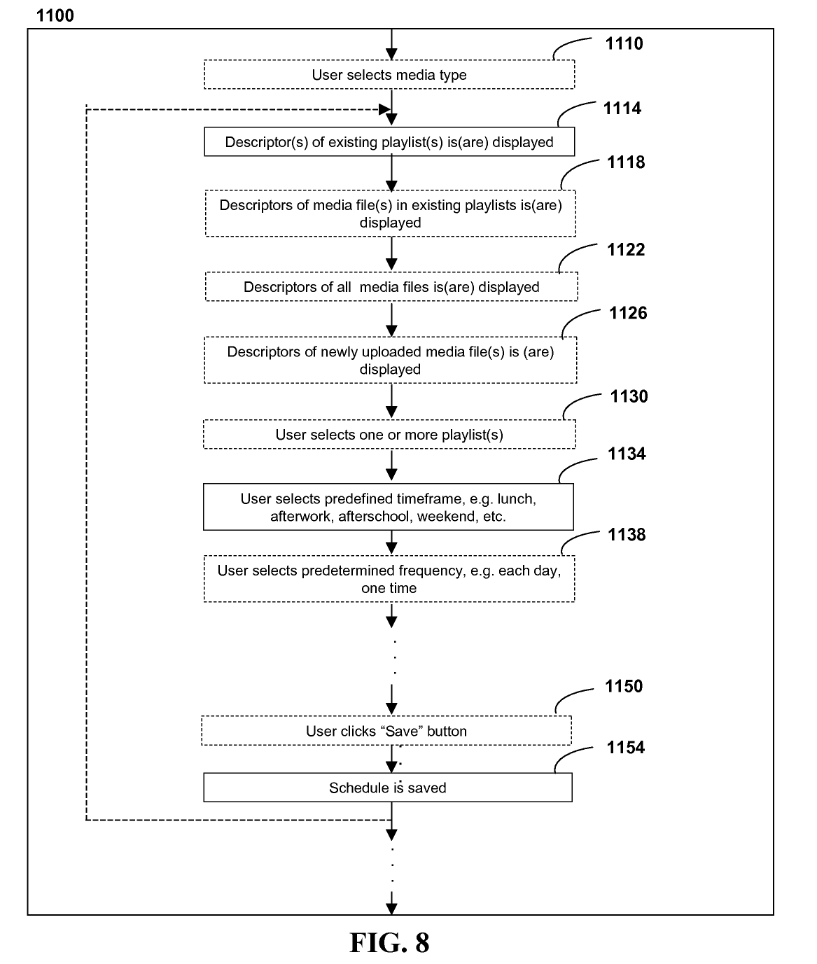

In FIG. 8, the process comprises selecting a predefined schedule for transmission of a playlist. The process includes the steps 1114, 1134 and 1154. The process may also include alternative and/or additional steps 1110, 1118, 1122, 1138 and/or 1150.

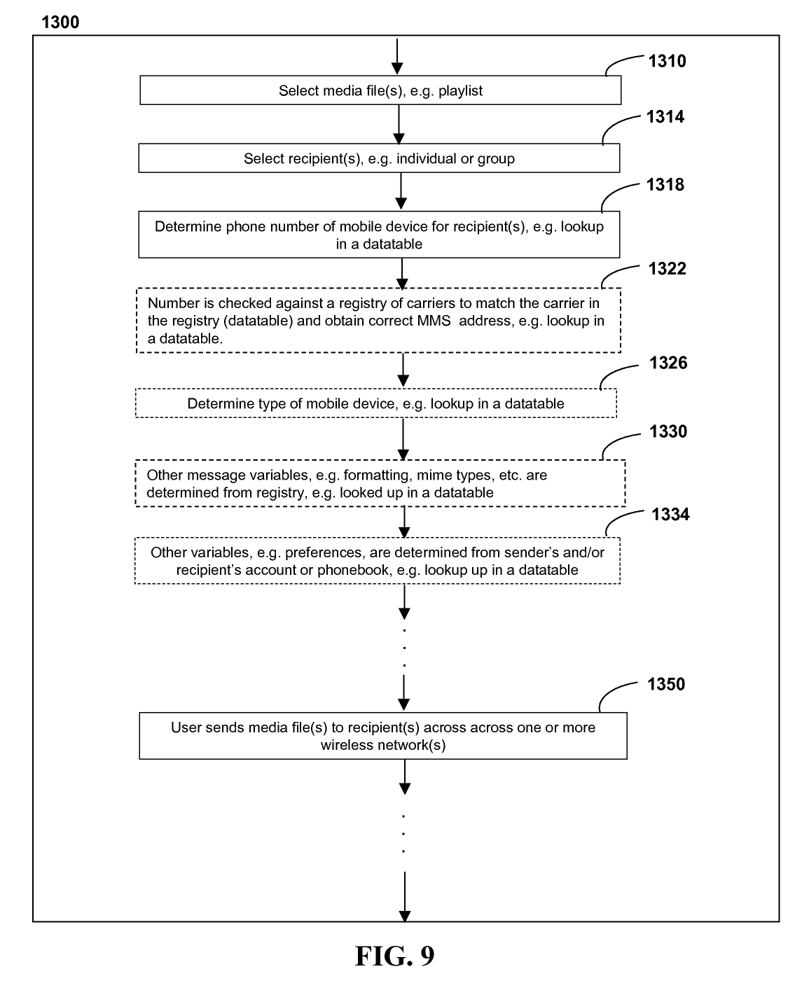

In FIG. 9, the process comprises transmitting a playlist to one or more mobile devices across one or more wireless network(s) initiated by a user. The process includes the steps 1310, 1314, 1318, and 1350. The process may also include alternative and/or additional steps 1322, 1326, 1330, and/or 1334.

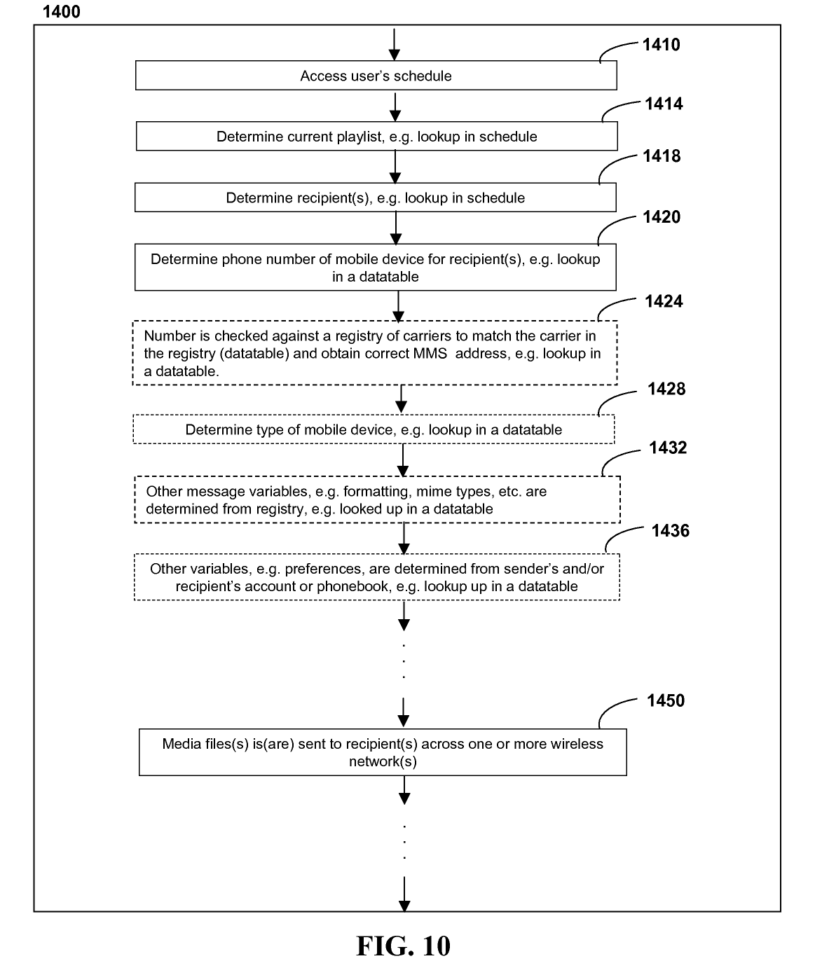

In FIG. 10, the process comprises transmitting a playlist to one or more mobile devices across one or more wireless network(s) according to a predetermined schedule. The process includes the steps 1410, 1414, 1418, and 1450. The process may also include alternative and/or additional steps 1422, 1426, 1430, and/or 1434.

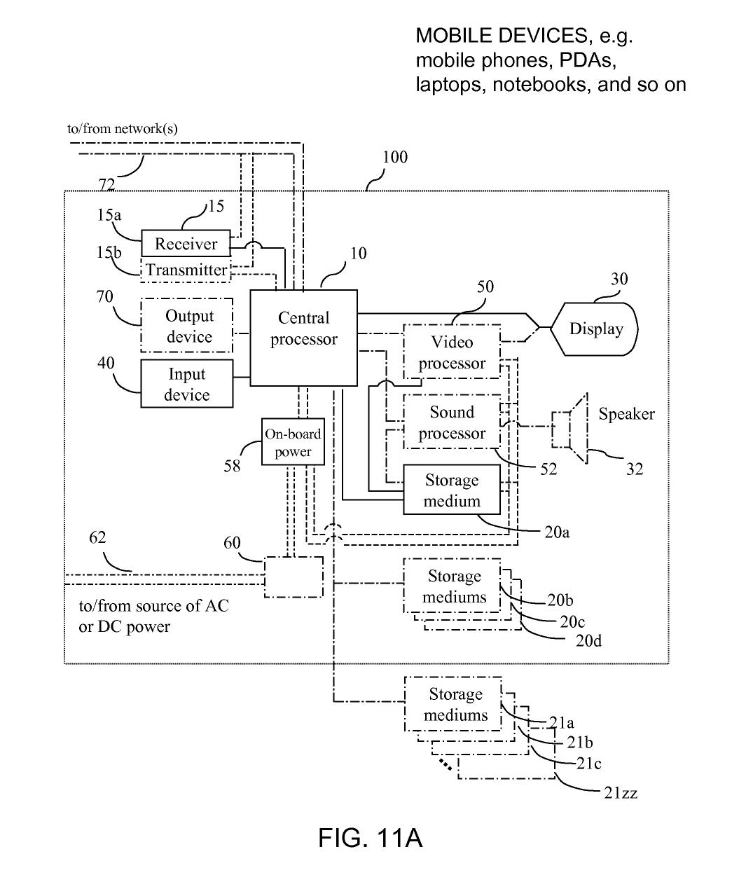

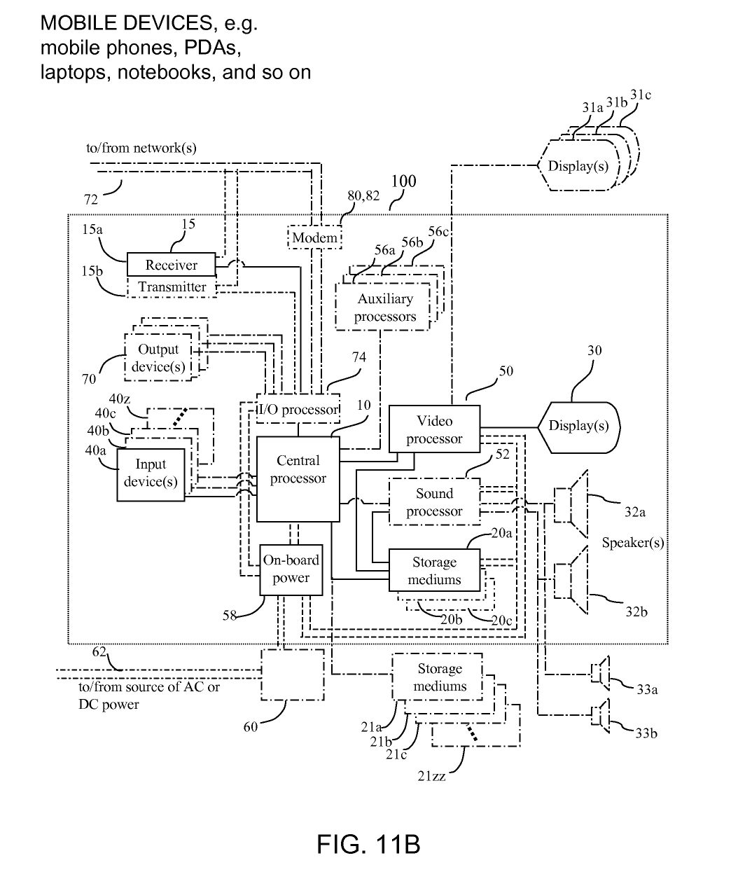

With reference to FIGS. 11A, 11B, 12A through 12C, 13A through 13E, and 14A through 14E, a mobile electronic device is depicted by numeral 100 and any other electronic device is depicted by numeral 110. The mobile device 100 may include any electronic device including a mobile phone, a PDA, a hybrid PDA and phone, a mobile computer such as a laptop, notebook, tablet, and so on, as the term “device” is defined herein. The other electronic device 110 may be a desktop, workstation, mainframe, server, control unit for a building automation system, control unit for a telecommunication system, or other immobile electronic device.

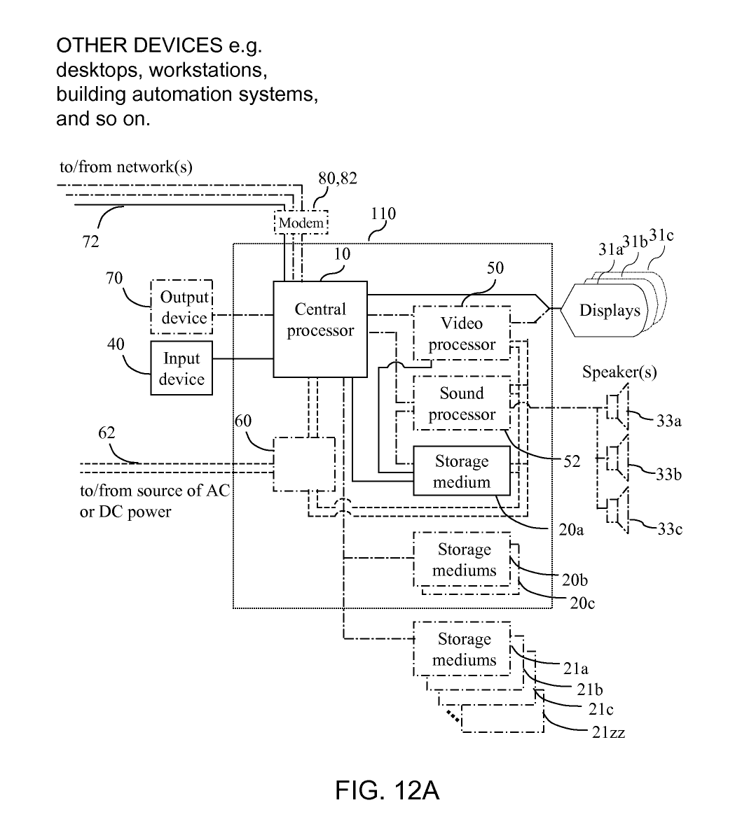

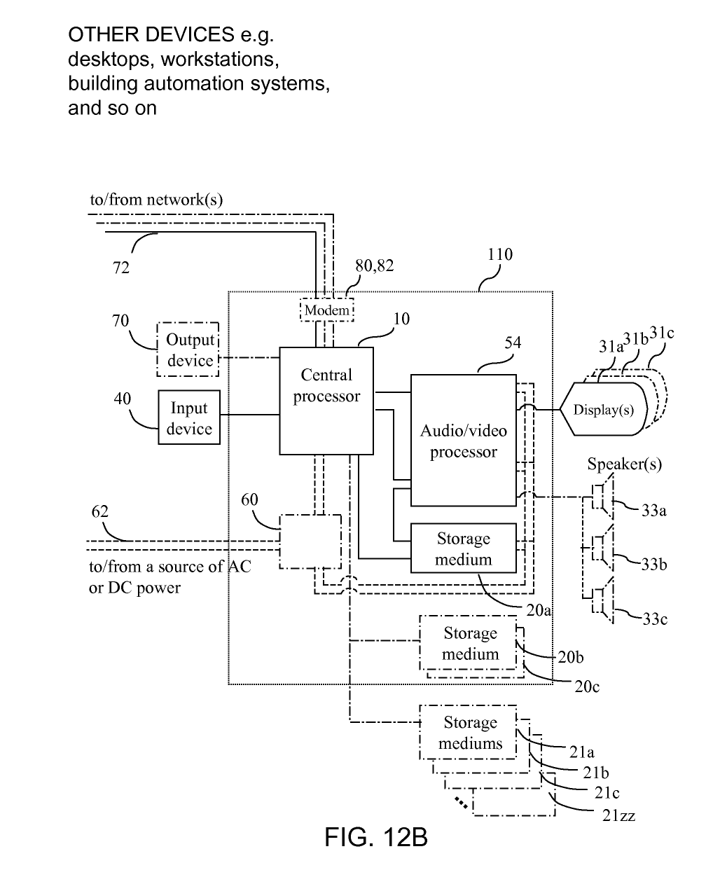

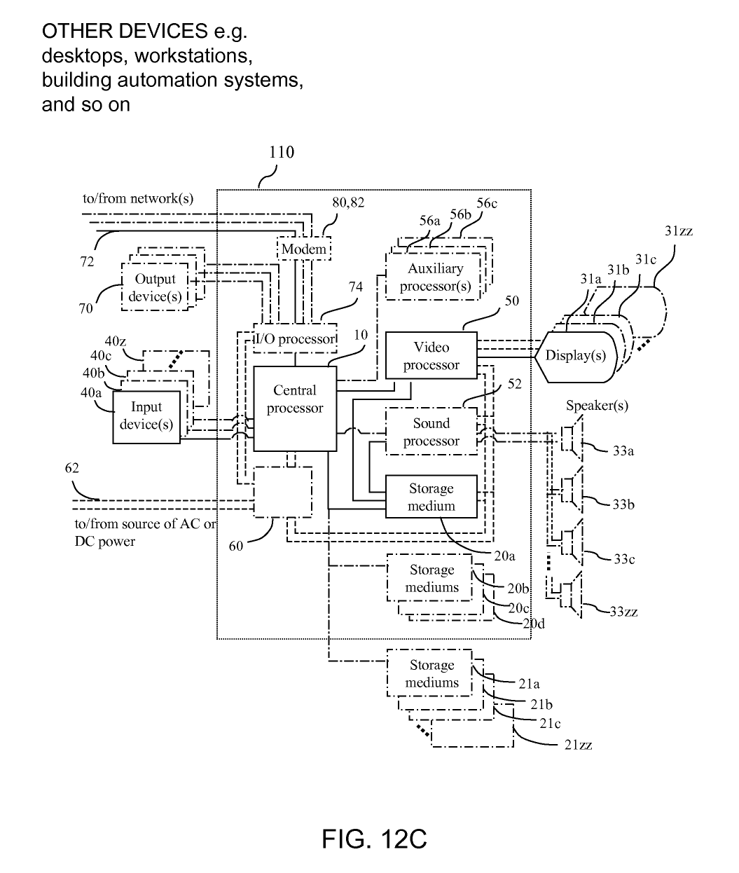

With reference to FIGS. 11A, 11B, and 12A through 12C, the perimeter of the device is shown by dotted lines, electric power (or bus) lines are shown by dashed lines, and alternative components and devices are shown by phantom (or dot-dash) lines.

FIGS. 11A and 11B are schematic drawings of alternative circuits of a mobile device 100 having a central processor 10 in communication with at least one storage medium 20a. In one embodiment of the invention, the circuit comprises the central processor 10, the storage medium 20a, at least one display 30, and at least one on-board power source 58. For example, the display can be any type of display including a flat panel display such as LED, LCD, TFT, plasma, and so on, or a combination of these including a backlit display. For example, the on-board power source may be a battery, a fuel cell, a photovoltaic cell, and so on. In another embodiment, the central processor is in communication with a receiver 15a and at least one speaker 32, and in another embodiment, the central processor is in communication with a transmitter 15b. In still another embodiment, the circuit comprises a sound processor 52 in communication with the central processor and the speaker 32. In one embodiment, the central processor 10 is in communication with a wireless cellular network of the type operated by Verizon, Sprint or AT&T through the receiver 15a and the transmitter 15b. In still another embodiment, the central processor is in communication with the receiver/transmitter 15 which comprises a receiver 15a and/or transmitter 15b. In still another embodiment, the device comprises at least one input device 40. In yet still another embodiment, the circuit also comprises a video processor 50 in communication with the central processor and the display. In a further embodiment, the circuit also comprises one or more additional storage mediums in communication with the central processor where the additional storage mediums may be internal storage mediums 20b, 20c, and 20d and/or external storage mediums 21a, 21b, 21c . . . 21zz. The second storage medium may be flash memory or any type of external device capable of storing data including but not limited to a memory stick, CF card, a SD card, a jump drive, and so on. In still another embodiment, the circuit also comprises an output device 70 in communication with the central processor. In still another embodiment, the central processor is in communication with a server 200 at a remote location whereby information is transmitted to and from the remote location. In yet still other embodiments, the device 100 has additional displays 31a, 31b, and 31c and/or additional speakers 33a and 33b. In still yet another embodiment, in addition to the onboard power source 58, the device 100 has a connection to an external power source 62, and as necessary, a transformer 60. The transformer may be a AC-to-DC converter, a step down transformer, or any type of transformer or adapter.

With reference to FIG. 11B, the circuit includes an input-output processor 74 which is in communication with the central processor 10. In another embodiment, the input-output processor 74 is in communication with a modem 80 and/or a wireless network adapter 82 which in turn is connected to a network 72. In still another embodiment, the modem 80 or network adapter 82 is an external component rather than an internal component. In still another embodiment, the device 100 includes additional input devices 40a . . . 40z such as alternative keys, touchpads, or touchscreens for data entry, a microphone, and/or digital camera. In yet still another embodiment, the device 100 includes auxillary processor(s) 56a, 56b, and 56c in communication with the central processor 10.

FIGS. 12A, 12B and 12C are schematic drawings of alternative circuits of other electronic devices 110 including stationary electronic devices having a central processor 10 in communication with at least one storage medium 20a, and at least one input device 40, and at least one connection to an external power source 62. In one embodiment of the invention, the circuit comprises the central processor 10, the storage medium 20a, at least one display 30, and the input device 40. In another embodiment, the central processor is in communication with a network 72. In still another embodiment, the circuit includes at least one speaker 33a. In yet still another embodiment, the circuit also comprises multiple output devices 70, and/or network connections 72. In yet still another embodiment, a modem 80 and/or a wireless network adapter 82 is in communication with the central processor. In yet still other embodiments, the circuit also comprises multiple internal storage mediums 20a . . . 20c, external storage mediums 21a . . . 21zz, displays 31a . . . 31c, speakers 33a . . . 33c, input devices 40.

In FIGS. 12A, 12B & 12C, the central processor may be in communication with a network 72 and the device 110 has at least one input-output device 74. When in communication with the network 72, the input-output device 74 may be a network card of the type manufactured by Novell Communications of Provo Utah; a dial-up modem of the type manufactured by Hayes Corporation of Boston Mass.; or an alternative type of modem such as wireless, DSL, or cable modems. In the preferred embodiment, the I/O device 74 is a wireless modem because it has the capability to remain “always-on” similar to a mobile communications device.

With reference to FIG. 12B, the audio processor and video processor are a single audio-visual processor 54 which is in communication with the central processor 10 and/or one or more displays 31a . . . 31c and/or one or more speakers 33a . . . 33c. In another embodiment, the modem 80 and/or a wireless network adapter 82 is an internal component rather than an external component.

With reference to FIG. 12C, the circuit includes an input-output processor 74 which is in communication with the central processor 10. In another embodiment, the input-output processor is in communication with a modem 80 and/or a wireless network adapter 82 which in turn is connected to a network 72. In still another embodiment, the device 100 includes auxiliary processor(s) 56a, 56b, and 56c in communication with the central processor 10. In yet others embodiments, the circuit may include a series of displays 31a . . . 31zz, a series speakers 33a . . . 33zz, multiple input devices 40, and/or multiple output devices 70.

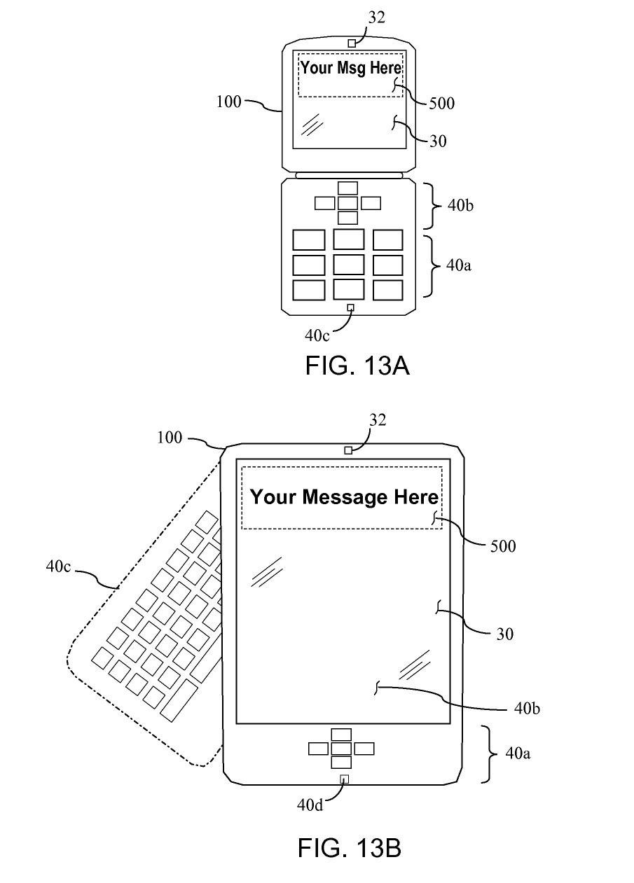

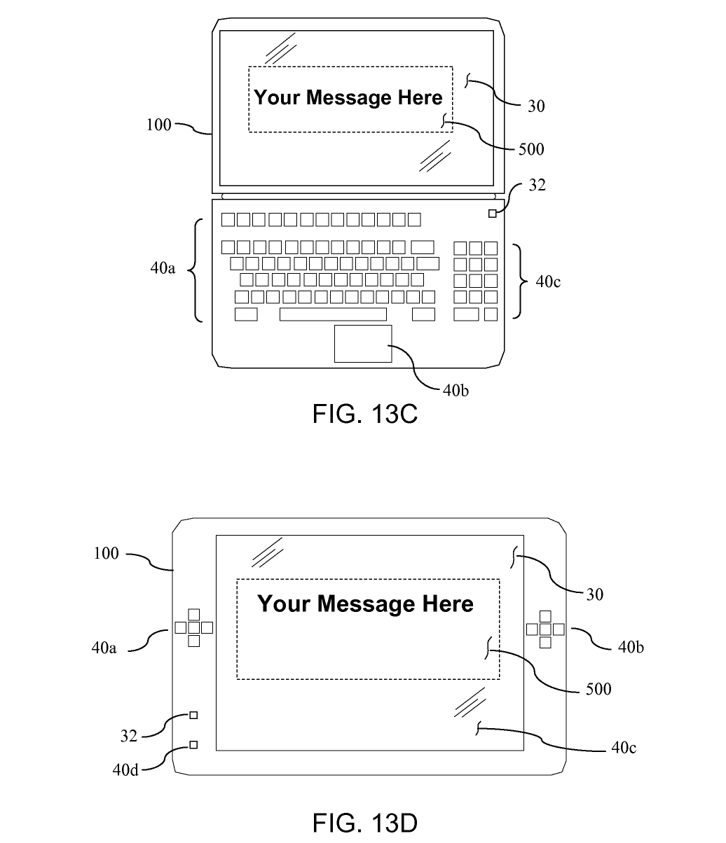

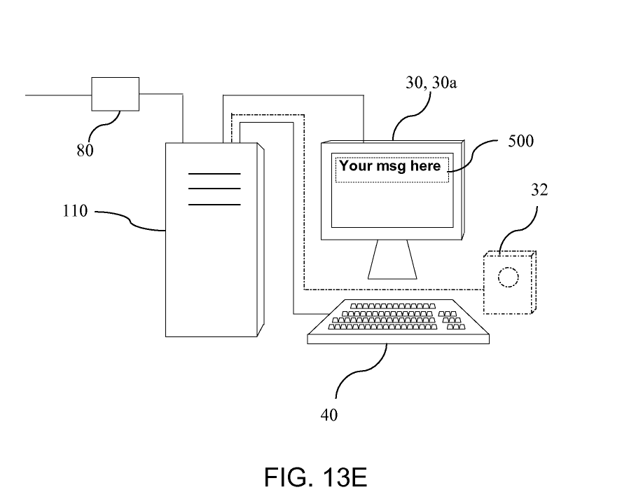

FIGS. 13A through 13D are perspective drawings of alternative mobile devices 100 having a display 30, a speaker 32, at least one input device 40, and at least one message display area 500. In one embodiment, the display 30 may be a flat panel display and the input device(s) 40 is may be one of several types including a number/letter keypad or navigation/execution keypad of the type manufactured by Samsung Electronics, or a touchpad of the type manufactured by Toshiba, or a touchscreen of the type made by Sony Electronics. In FIGS. 13A and 13B, the message display area 500 is shown at or near the top of the display 30 but may be located elsewhere on the display 30 or may be enlarged to encompass the entire display 30 or shrunk to a smaller size. Similarly, in FIGS. 13C and 13D, the message display area 500 is shown at or near the center of the display 30 but may be located elsewhere on the display 30 or may be enlarged to encompass the entire display 30 or shrunk to a smaller size.

In FIG. 13A, the device 100 has three input devices 40a, 40b and 40c corresponding to a number/letter keypad, a navigation/execution keypad, and a microphone, respectively. In FIG. 13B, the device has four input devices 40a, 40b, 40c and 40d corresponding to a navigation/execution keypad, a touchscreen, a number/character keypad, and a microphone, respectively. In FIG. 13C, the device has three input devices 40a, 40b, and 40c corresponding to a character keypad, a touchpad, and a number keypad, respectively. In FIG. 13D, the device has four input devices 40a, 40b, 40c and 40d corresponding to a first navigation/execution keypad at the left, a second navigation/execution keypad at the right, a touchscreen, and a microphone, respectively.

FIG. 13E is a perspective drawing of a stationary electronic device having a display 30, a speaker 32, at least one input device 40, and at least one message display area 500. In FIG. 13E, the message display area 500 is shown at or near the top of the display 30 but may be located elsewhere on the display 30 or may be enlarged to encompass the entire display 30 or shrunk to a smaller size. In FIG. 13D, the device has one input device 40 corresponding a keyboard.

The circuit and is powered by either an internal power source 15 or by an external source 62 of direct current (DC) power or alternating current (AC) power. Where the source is internal, the power source 15 may be including but not limited to a battery, a fuel cell, photovoltaic cell, and so on. Where the source is AC power, a transformer 60 is in communication with the source 62. The transformer may be a board-mounted transformer of the magnetic type manufactured by Hammond Manufacturing of Cheektowaga, N.Y. or a stand-alone power adapter of the type manufactured by Motorola Corporation of Schaumburg, Ill.

In one embodiment the storage medium(s) 20a . . . 20d may be a hard drive of the type manufactured by Quantum Corp. of Milpitas, Calif., and in another embodiment, the storage medium may be a flash memory device of the type manufactured by Sandisk. Alternatively, the central processor receives instructions and/or data from the storage medium 20 and/or a second storage medium 22. The second storage medium 22 may be a DVD, CDROM, memory stick, CF card, SD card, jump drive, programmable read only memory (PROM), electronically-alterable programmable memory (EPROM), or the like. In another embodiment, the second storage medium 22 is an integrated circuit housed within a game box. In still another embodiment, the second storage medium is a CDROM which is removeably connected to the circuit.

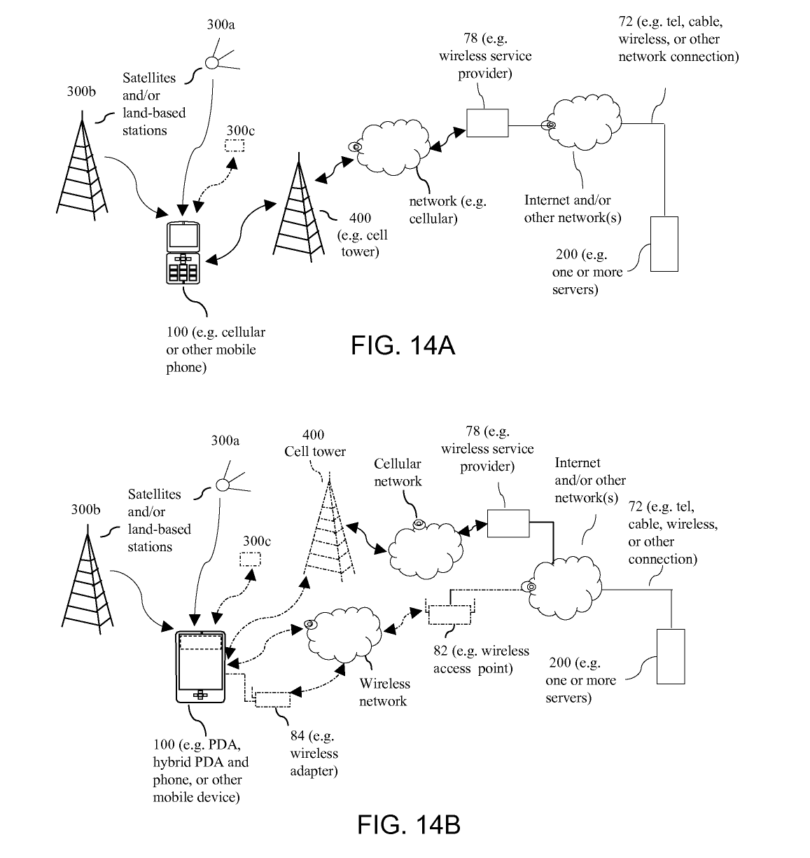

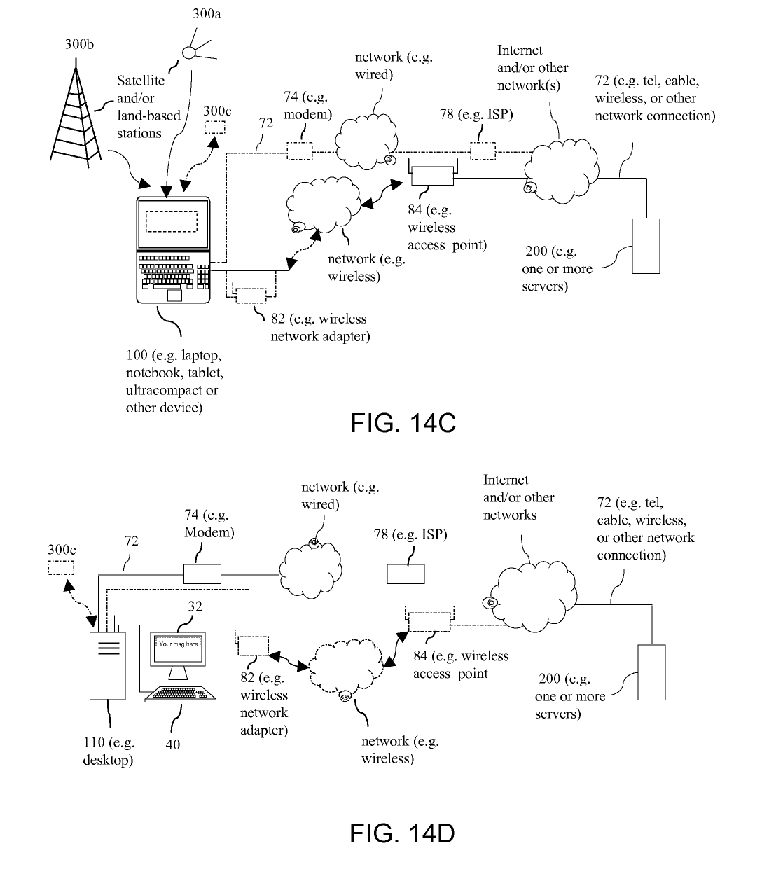

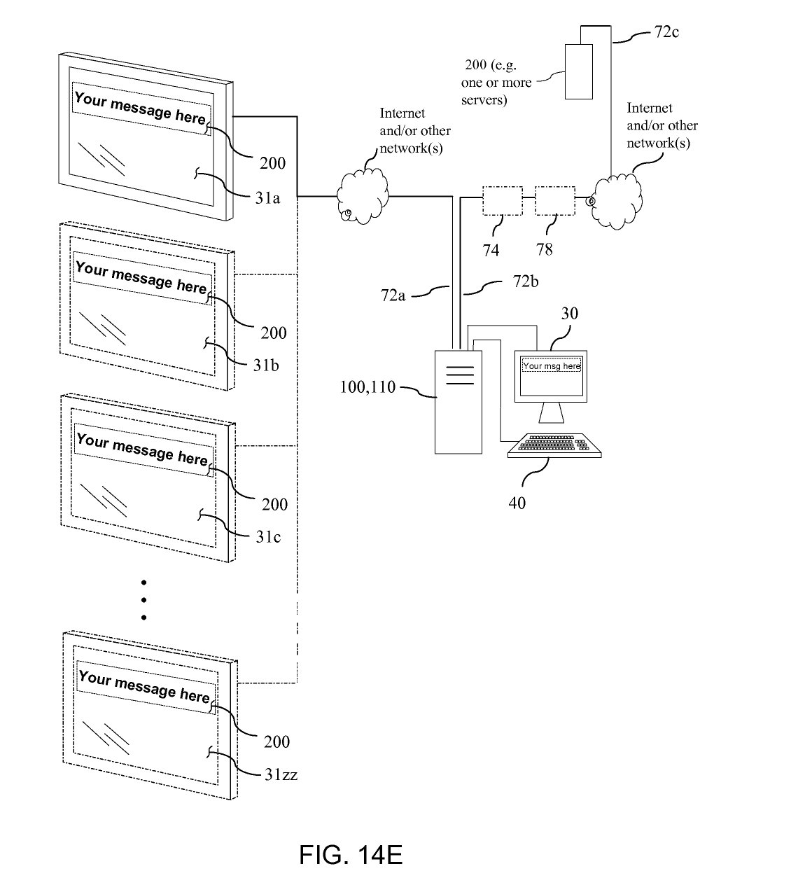

With reference to FIGS. 14A through 14E, a computer server is depicted by numeral 200. The computer server 200 may include any computer including a file server, a web server, and so on. Satellite-based positioning station(s) is/are depicted by numeral 300a, land-based positioning station(s) are depicted by numeral 300b, and source(s) using narrow cast or near field communications are depicted by numeral 300c. The positioning station(s) 300a may be located in geo-stationary orbit, the positioning station(s) 300b may be located in any fixed position on a temporary or permanent basis, and source(s) 300c may be located anyplace or located on anything, whether mobile or non-mobile, on a temporary or permanent basis. For example, source(s) 300c may be RFID tags, NFC chips, or the like.

Some examples to illustrate the methods and systems include the following non-exhaustive list of potential applications in Table 5 below:

TABLE 5
Potential Applications

| | Media Type | | | | Interactivity | |
|---|---|---|---|---|---|---|
| Potential Application | Music | Video | Image | Text | Yes | No |
| Mobile phone as MP3 player | X | | X | | | X |
| Mobile phone as Podcast player | X | X | | | | X |
| Mobile phone as portable TV | X | X | | | X | |
| Mobile phone as portable slide | | | X | X | X | |
| viewer | | | | | | |
| Mobile phone as video phone | X | X | | | X | |
| Mobile phone as e-book reader | | | X | X | | X |
| Mobile phone as collaboration | X | X | X | X | X | |
| tool or as portable white board | | | | | | |
| device | | | | | | |
| Mobile phone as portable RSS | X | X | X | X | X | |
| viewer | | | | | | |
| Mobile phone as voting machine | X | X | X | X | X | |
| or as polling/surveying device | | | | | | |
| Others . . . | X | X | X | X | X | |

The invention may be practiced on any computer or electronic device capable any manner or form of visual display. All types of computers, computer systems, and computer networks having the capability of a visual display can generally be programmed to operate computer games and interactive programs. Even those without capability of visual display can be programmed to operate a variety of computer games or interactive programs. In addition, many electronic devices can be programmed to operate a computer game or interactive program.

Electronic devices may include any type of computer and computer system such as personal computers, laptop computers, notebook computers, handheld computers, arcade game machines, handheld games, video game systems, video game consoles, video game boxes, personal digital assistants, mobile computing devices, cable boxes, telephones, telecomputing devices, and telecommunication devices. The processes, subprocesses, and algorithms may be processed on a single processor, an array of processors, separated into two portions corresponding to server side or device side, or split in any number of ways. The processor(s) may comprise one or more processors such as a single integrated circuit or multiple integrated circuits having different functions i.e. central processing unit (CPU), input-output (I/O) processing, video processing, audio processing, transmission, reception, and so on. The display(s) may be any type of analog or digital CRT display including monochrome or color monitor, TV, DTV, HDTV, and so on, and any combination of these such as array of CRTs; any flat panel display including but not limited to LCD, TFT, plasma, and so on, or any combination of these such as an array of LCDs; or a analog or digital projection system such as front projection or rear projection of the types manufactured by Sony Electronics of San Diego, Calif., and Da-Lite of Warsaw, Ind., or such as LCD or DLP of the type manufactured by InFocus of Wilsonville, Oreg., and so on.

The methods and systems of the present invention include processes, subprocesses, and modules which may be used separately, and also in conjunction with one another. Modules may comprise source that is interpreted or the source code may be compiled into executable code. The method and systems may use the results created by any process, subprocess and/or module of this invention for any purpose including but not limited to creating, adapting, or mobilizing web content for viewing on mobile devices.

The methods and systems of the invention also include processes and subprocesses, which may be used separately, and also in conjunction with one another. These may be run independently, in series, in parallel or in any combination. The methods and systems may use the results created by any process and/or subprocess of this invention for any purpose including distributing of targeted message(s), or advertising, marketing, or other promotion.

From the foregoing it will be appreciated that although specific embodiments of the technology have been described herein for purposes of illustration, various modifications may be made without deviating from the spirit and scope of the invention. For example, the user may lease products or services rather than purchase them outright. Also, the user may provide personal information as consideration in addition to or in lieu of payment for products and services. A message or information may be presented in ways other than visual display. For example, a message or information may be output in an audio form. Further, the invention can be used with mobile phones, desktop or personal computers, computer terminals, TVs and monitors, video game machines, video game boxes, web TV, cable TV, CCTV, video consoles, laptop computers, notebook computers, handheld computers, personal digital assistants, telephones, cell phones, pagers, and so on. Accordingly, the invention should be broadly construed and should not be limited.

What is claimed is:

1. A method comprising:
uploading a plurality of media files;
grouping one or more the media files in a playlist; and
transmitting the playlist to a mobile device;

2. The method of claim 1 wherein the media files comprise music.

3. The method of claim 1 wherein the media files comprise video.

4. The method of claim 1 wherein the media files comprise images.

5. The method of claim 1 wherein the media files comprise music and text.

6. The method of claim 1 wherein the media files comprise video and text.

7. The method of claim 1 wherein the media files comprise images and text.

8. The method of claim 1 wherein the media files comprise interactive media.

9. The method of claim 1 wherein the mobile device is a mobile phone.

10. The method of claim 1 wherein the method has an additional step of scheduling the transmission of playlists such that the playlist is transmitted on predetermined schedule.

11. The method of claim 1 wherein the method has an additional step of recipient saving playlist on mobile device.

12. The method of claim 1 wherein the method has an additional step of recipient sending a reply to sender of playlist by electronic means.

13. A method comprising:
purchasing a plurality of media files;
grouping one or more of the media files in one or more playlists; and
transmitting one or more the playlists to a mobile device;

14. The method of claim 13 wherein the mobile device is a mobile phone.

15. The method of claim 13 wherein the method has an additional step of scheduling the transmission of playlists such that playlists are transmitted at a predetermined time.

16. The method of claim 13 wherein the method has an additional step of shuffling or randomizing one or more playlists prior to transmission of the playlists to the mobile device.

17. A method comprising:
selecting a plurality of media files;
grouping one or more of the media files in at least one playlist;
converting a playlist into a resulting media file; and
transmitting the resulting media file to a mobile device.

18. The method of claim 17 wherein the resulting media file is encoded as an audio file.

19. The method of claim 17 wherein the resulting media comprises a plurality of music files.

20. The method of claim 17 wherein the resulting media file is encoded as a video file.

21. The method of claim 17 having the additional step of encoding at least one image or video file in the resulting media file.

22. The method of claim 17 wherein the resulting media comprises a plurality of music files and a slideshow of images.

23. The method of claim 17 wherein the resulting media comprises at least one music file and at least one video file.

24. The method of claim 17 wherein the resulting media comprises a plurality of images files in a slideshow with or without music.

25. The method of claim 17 wherein the resulting media comprises at least one advertisement.
